(19) United States
(12) Patent Application Publication
(10) Pub. No.: US 2022/0347547 A1
(43) Pub. Date: Nov. 3, 2022

(54) PAR GOLF INTERNET GAME

(71) Applicant: Trevor Lucey, La Mesa, CA (US)

(72) Inventor: Trevor Lucey, La Mesa, CA (US)

(21) Appl. No.: 17/548,530

(22) Filed: Dec. 11, 2021

Related U.S. Application Data
(60) Provisional application No. 63/205,481, filed on Dec. 14, 2020.

(51) Int. Cl. A63B 71/06

(52) U.S. Cl. CPC A63B 71/0616; A63B 2102/32

(57) ABSTRACT

An Internet game for recording and transmitting the activity of each group of golfers participating in a golf tournament at a tournament site and permitting contest players to win points in the game by accurately predicting the golfers who will shoot par during the last round of the golf tournament. In preferred embodiments the game is designed to increase public interest in the game of golf and in the best golfers in the world and provide to the entire world a system and method for providing a real time view of every golf shot in the final day of golf tournaments such as the weekly PGA golf tournaments.

This application claims the benefit of Provisional Application Ser. No. 63/205,481, filed Dec. 14, 2020. The present invention relates to facilities for conducting Internet games and in particular to such facilities and games based on golf tournaments.

### FIELD OF THE INVENTION

### Background of the Invention

### Internet Games

Internet games are well known all over the world. These games include word games, action games (including war games) and many other games including games relating to the game of golf. The games typically have sponsors and participants in the game are typically presented with a variety of advertisements. Most of the games are free but some require some type of fee.

### Early 90's Automated Golf Games

During the early 1990's the Applicant applied for and was granted two patents covering an automated golf sweepstakes-type game. These were U.S. Pat. No. 5,043,889 issued Aug. 27, 1991 and U.S. Pat. No. 5,332,218 issued Jul. 26, 1994. The teachings of both of these patents are incorporated herein by reference. In both patents equipment was described that would allow many thousands of players to participate in games where the winner of the games was based on the accurately predicting the outcome of golf tournaments such as the Professional Golfers Association (PGA) golf tournaments. Two techniques were described to permit the players to make their predictions utilizing automated computer-controlled equipment. In the first technique the players made their predictions by shading in portions of a coupon like an IBM card to indicate their predictions. Special card readers were identified that would be made available at sponsors locations that would automatically read the cards and provide the predictions to a master computer that would record the prediction. The players were required to obtain coupons from sponsors of the games as a part of a marketing program. In another embodiment players could make their prediction via touch tone telephone with a call to a computer controlled answering service. In this case a prerecorded audio instruction would guide the player to make his prediction by typing numbers on his telephone corresponding to his prediction.

### Par

In golf PAR is the predetermined number of strokes that a scratch (or 0 handicap) golfer should require to complete a hole (typically 3 to 5 strokes). Strokes to complete an 18-hole round is about 72. A typical tournament may be four rounds. Pars are the central component stroke play, the most common kind of play in professional golf tournaments. Stoke play is the scoring system typically used in tournaments in which the total number of strokes are accumulated for each round of the tournament to determine the tournament winner.

The length of each hole from the tee placement to the pin generally determines par values for each hole. Almost invariably, holes are assigned par values between three and five strokes, which includes the tee shot and two putts.

For a casual player from the middle tees, a par-three hole will be 100-250 yards (90-230 m) from the tee to the pin. Par-four holes are 250-470 yards (230-430 m), but tournament golfers will often encounter par-four holes 500 yards (460 m) or more, as it is common for short par-five holes for normal play to be turned into par-four holes in championship play. Par-five holes are typically 470-600 yards (430-550 m), but in the modern game holes of over 600 yards are becoming more common in championship play. Other relevant factors in setting the par for the hole include the terrain and obstacles (such as trees, water hazards, hills, or buildings) that may require a golfer to take more (or fewer) shots. Some golf courses feature par-sixes and, very rarely, par-sevens, but the latter are not recognized by the United States Golf Association.

Typical championship golf courses have par values of 72, comprising four par-threes, ten par-fours, and four par-fives. Championship course par can be as high as 73 to as low as 69. Most 18-hole courses not designed for championships have a par close to 72, but some will be lower. Courses with par above 73 are rare. Courses built on relatively small parcels of land will often be designed as “Par-3 Courses” in which every hole (or almost every hole) is a par-three (for a total par of 54 or slightly higher over 18 holes).

### The PGA Tour

The Professional Golfers Association of America (PGA) is an organization of golf club and teaching professionals which runs numerous tournaments at the local level across the United States. The PGA Tour is a separate organization of professional players that runs elite men's competitions, including the PGA Tour, Champions Tour and Nationwide Tour. Top-level women's competitions are run by the Ladies Professional Golf Association. Rules for the organizations' various events can differ slightly, but the basic guidelines are consistent.

Players qualify for PGA tournaments in various ways. On the PGA Tour, for example, many players qualify by earning a PGA Tour card via the annual Q School competition. Each tournament has some leeway with respect to its qualification standards.

During most PGA Tour events, the field is reduced after 36 holes to the 70 lowest-scoring golfers, including ties. In accordance with a PGA Tour rule enacted in February 2008, if more than 78 golfers make the 36-hole cut, another cut to the lowest-scoring 70 golfers plus ties is made after 54 holes. Fields in golf tournaments are larger than the total number of available places. A cut is used to determine which players will make it to play into the weekend and, in doing so, will qualify to receive a prize from the tournament based on their place of finish. All players that qualify for or are given a spot in a tournament are permitted to play the work week rounds: 18 holes on Thursday and 18 holes on Friday, in the case of most 72-hole tournaments. These first two rounds are used to rank the players, by score headed into the weekend. These rounds feature pre assigned groups of three players, in most tournaments, and the players are not re-paired to reflect leader board position after day one.

The Cut

The typical cut line for a PGA event after two rounds is the score of the 70th lowest scoring golfers. Any players that finish with that score or better are considered to have made the cut and continue play in the weekend rounds, unless the number of players in the tie merits further tie-breaking. When more than 78 players make the cut, it is necessary to apply further tie breaking procedures to determine which golfers get to play in the remaining rounds. In this case, the next highest score below that of the 70th player is used, and it is determined how many players would make the cut should that be the line. Whichever number is closer to 70, either the number of players at the original line or the number of players at the lower line, is used as the cut for which players make the weekend, meaning less than 70 players can potentially qualify. Should a cut like this occur, the players that made the 70th-place tie cut but were eliminated anyway receive a check but do not play further. Should the higher cut line be used following 36 holes, and more than 78 players qualify for the next round, a second cut occurs after 54 holes. This cut uses the same procedures (top 70 and ties) While this cut does not determine if the players receive money for their performance, it does determine which players are permitted to play the next, usually final, round. Some events utilize a 10-stroke cut rule, under which any player within 10 strokes of the leader after two rounds is permitted to play the weekend, even if the player ranks worse than 70th. This is primarily used in major tournaments, where the course is very difficult and a player who goes out and shoots a score in the mid-60s can climb through the field quickly.

### Foursomes, Threesomes and Twosomes

PGA Tour events typically feature threesomes for the first two rounds of stroke play tournaments, then switch to twosomes for rounds three and four, after the field has been cut. A pro-am event typically begins with foursomes, as one tour pro plays with three amateurs.

### The Internet

Since the early 1990's the Internet has become available to the large majority of the people in the world. Most businesses in the United States have a web site which is used by the business to promote its interests. Web sites can be made interactive so that visitors to the web sites can communicate with the web site computer.

### Objectives of the Invention

An objective of the invention is to utilize the Internet for conducting an Internet golf game based on participants predicting a portion of the outcome of golf tournaments. It is also an object of this invention to provide facilities that will enable the sponsors of the contests to evaluate all of the many expected entries using computer equipment so that the winner or winners can be determined quickly and efficiently. Another objective of the invention is to develop interest in and promote the products and services of sponsors of the Internet golf game, golf interests in general and of the advertisers which advertise their products and services in connection with these golf tournaments including television broadcasts, magazines and newspapers. Another objective of the invention is to promote golf interests in general. Where laws permit, another objective of this invention is to provide a method for efficiently operating a contest for profit where contest participants would pay for the opportunity to play the Internet golf game in hopes of winning a prize.

### SUMMARY OF THE INVENTION

The present invention provides a system and method for running an Internet golf game whereby the participants seek to win the prizes by accurately predicting certain results of a golf tournament such as the weekly PGA golf tournaments. In preferred embodiments, preferably referred to as the “Par Golf Internet Game” (PGIG) the players of the game are asked to predict:
The golfers who will shoot par on the last day of the tournament.

This invention is designed to increase public interest in the game of golf and in the best golfers in the world or regions of the world. The present invention also presents to the entire world equipment and a method for providing a real time view of every golf shot on the final round of golf tournaments such as the weekly PGA golf tournaments.

### BRIEF DESCRIPTION OF THE DRAWINGS

FIG. 1 is a drawing of a proposed fill-in-the-blanks computer form showing the names of the golfers who made the cut for the John Deere Classic held on Jul. 10-13, 2019 to simplify the process of prediction of par shooters by sweepstakes players.

FIG. 2 lists the names of the par shooters on the last day of the above tournament and the winner of the tournament

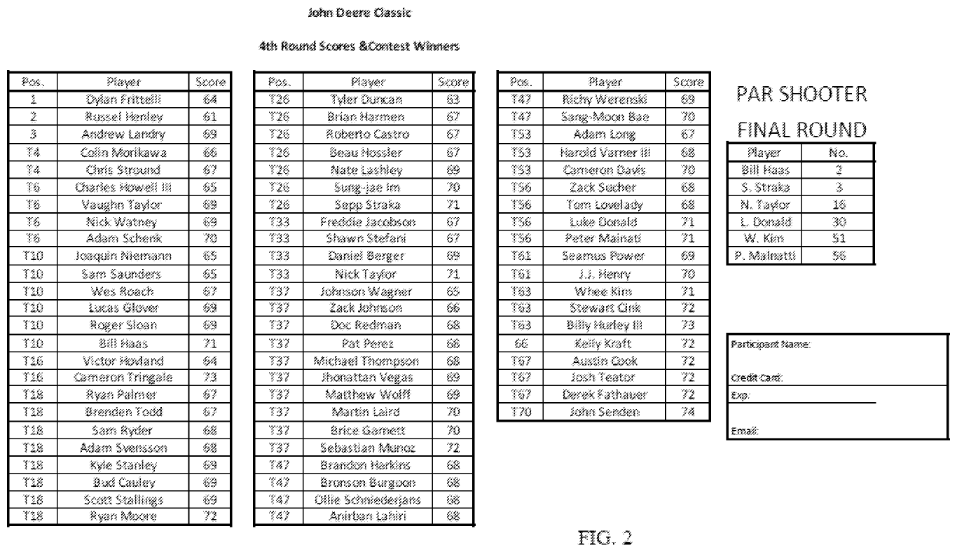

### DETAILED DESCRIPTION OF THE INVENTION

### Real Time Recording of Each Golf Shot

In preferred embodiments a monitor (which could be an unpaid volunteer) follows each of the golfing groups on the last day of the tournament with a video camera device (which could be a cell phone) and the monitors record each golf shot of each of the golfing groups participating in the last round of the tournament and provides conversation to go along with the video. (The golfing groups consists typically of about 35 twosomes, but could include foursomes, threesome or a single golfer.) Preferably the monitors will be cautioned to position himself or herself so that he or she is not visible to the golfer and to not speak during the period from when the golfer addresses the golf ball until after the ball has been hit. A portable tournament server computer is positioned at the site of the tournament that is in communication with each of the approximately 35 monitors. The videos recorded by the monitors are preferably directed by the server to a cloud network which includes one or more computers programmed to collect the video results approximately real time from each group which typically will be a pair of two golfers.

### Golfer Comments

In preferred embodiments the monitors and each golfer in each group will have the option to wear a microphone that may be keep active or turned off. The monitor or an assistant to the monitor for each golfing group may be provided with communication equipment that will permit communication via communication with the tournament server computer. This added feature will potentially allow viewers all over the world to listen in on the conversations among the golfers, their caddies, other golfers, the monitor and others. A time delay of a few seconds to permit the Internet Golf Game Operator (sometime hereinafter referred to as “Operator”) to delete inappropriate information that should not be made available to the audience of the Internet golf game.

### Video Player Board

A video player board is provided at a convenient location at the site of the tournament that includes enough television-type or computer monitors that (to the extent feasible) displays approximately real time each golf shot of the tournament. Persons attending the tournament therefore may stand or sit at the location of the video player board and watch every (or almost every) golf shot of the tournament. Attendees will also be able to use their cell phones to listen serially to the commentary of the monitors of their choice.

### Mobile Operating Systems

Preferred embodiments will include software prepared utilizing a mobile operating system such as the Android Mobile Operating System or the iOS Mobile Operating System.

### World Wide, Real Time Video Distribution of Each Golf Shot

The invention also includes an application that can be downloaded to personal computers (PCs) and cell phones that permits the users of the PCs and cell phones to receive (approximately real time) the live video recording of each golfer group in the tournament. Therefore, every (or almost every) person in the world that is connected to the Internet or a participating television channel can watch as much of the tournament as he or she desires. In many homes there are multiple PCs and cell phones. Each one of these cell phones and computers can be utilized to permit several viewers follow several separate golfer groups simultaneously.

### The Par Golf Internet Game

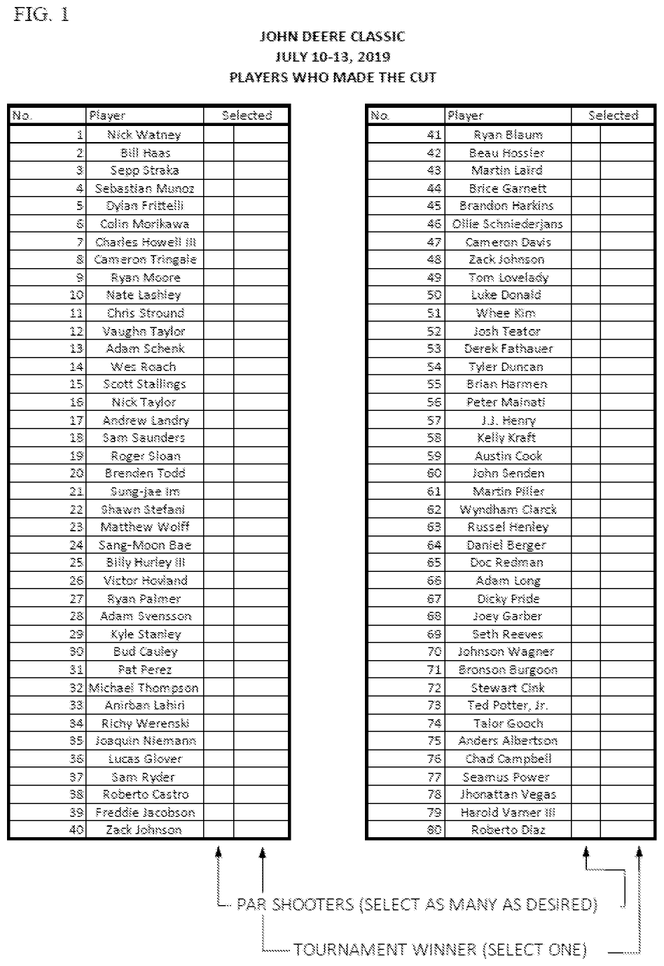

To increase the interest in tournaments this invention includes a contest, that is similar the one originally patented by the present inventor in 1991 and referred to in the Background section. Par golf Internet game participants may participate via the Internet preferably through a smart phone, a computer or similar device. A par golf Internet Operator will prepare a smart phone application or down-loadable software which will permit the participants to participate according to rules of the par golf Internet game. Persons who down-load the application or other software can use their devices as soon as the cut is determined each week and the names of the approximately 70 golfers making the cut are determined in order to make their selection of the players who they believe will shoot par in the final round of the tournament. In a preferred embodiment the Operator will make available at his web site a fill-in-the-blank or click-on form such as that shown in FIG. 1 which includes the names of the golfers who made the cut so that the participants can easily select the names of the golfers that the participants predicts will shoot par on the last day of the tournament. Persons who want to participate in the game will fill in blanks in an Internet form (not shown) that provides enough information to identify the par golf Internet participants. This could include his name, address and phone number and his birth date and, if a fee is to be charged to the participant, appropriate credit card information permitting payment of a participant fee (which, for example, could be $5.00). This information must be enough to distinguish the player from all other participants. Prior to the final round each participant will be provided with a list of the names of all of the golfers who make the cut. The participant will identify (from a list of golfers that survived the cut) a list of golfers that the participant predicts will shoot par on the last day of the tournament and his prediction of the tournament winner. If the Operator determines that the credit card information and other information complies with the rules of the par golf Internet game, the Operator will transmit to the participant, a notice confirming the identity of the participant and his prediction of the tournament winner and the predicted par shooters. The participant's name, birthdate and selection of par shooters is added to a list of all other participants available at the Operator's web site. (Participants may use a fictitious name and birthdate, but the credit card information [including the name on the credit card] must be accurate.). The operator uses a number (for example, 1 to 70 as shown in FIG. 1) or develop simple acronyms such as a combination of the golfers' initials plus enough other information to distinguish each golfer from all other golfers participating in the tournament.

In preferred embodiments, for example, participants will receive five points for correctly predicting the tournament winner plus one point for each correct pick of par shooters and minus one point for each incorrect pick of par shooters. The Operator preferably will identify the winner or winners of the par golf Internet game at approximately the same time as the operator identifies the winner of the tournament. The prize will be determined by the operator. A suggested prize could be 80 percent of the total of the total payments of participant fees of all participants. In that case the operator would retain 20 percent of the total of the payments. If there is more than one participant that have the highest score, the prize will be shared equally by the participants with the highest score. Preferably, the winner's or winners' share will be paid by the Operator of directly to the credit card organization that the participant used for the payment. This payment will be for the benefit of the winner or winners if there is a tie.

### Alternative Process for Sharing the Prizes

If the number of participants is very large the Operator may choose to spread the prize money. One technique could be as follows:
A) The Operator retains 24% of the total fees paid for the particular game (Game Fees).
B) Participants with highest scores share 40% of the Game Fees.
C) Participants Players with second highest scores share 20% of the Game Fees.
D) Participants Players with third highest scores share 10% of the Game Fees.
E) Participants Players with fourth highest scores share 5% of the Game Fees.
F) Participants Players with fifth highest scores share 1% of the Game Fees.

### Other Variations

The Operator may limit each Participant to participate only once for each tournament or the Operator could establish some other limit such as no more than ten participations. Alternatively, the Operator may allow participants to participate as many times as the participant desires with a payment of a participant fee for each participation. The proposed $1.00 payment to participate may be increased or decreased by the Operator; but Applicant suggests it be kept low to increase the number of people participating. Various obvious techniques can be utilized to prevent or minimize participants from participating more times than the Operator desires. However, each member of a family with his or her own credit card should be permitted to participate (including children with permission of their parent or guardian) but only to the extent permitted by law. (Alternatively, the Operator may establish a second game whereby under-age people are permitted to participate for free and a special nonmonetary prize or prizes are provided for the under-age participants.)

The Operator of the par golf Internet game may permit limited advertising and revenue received may be utilized as determined by the operator as described in more detail below. Applicant suggests that a portion of advertising revenue be reserved for charitable purposes. Also, a portion of the advertising revenue could be utilized to benefit the tournament golf course. No portion of the Sweepstake Participant fees should be paid to the tournament golfers directly or indirectly.

Applicant expects that for a typical PGA golf tournament there may be several million par golf Internet participants, so the central control computer must be able to handle enormous quantities of data. Public or private cloud systems may be utilized to handle the data that will be involved in the process of producing each tournament. In addition to the above referred embodiment, other embodiments could utilize a variety of techniques to establish the criteria for success in the sweepstakes.

### Sponsor Persons or Organizations

The par golf Internet game may have multiple sponsors that could provide advertisement through the Internet to the participants. The Internet web site is in Internet communication with the web sites of all sponsor organizations. Sponsor persons or organizations (Sponsors) may download software from the Operator's website which permits the operator to communicate directly with all sponsor web sites. In this embodiment on Wednesday of each week the operator transmits details of the tournament planned for the weekend of that week to each sponsor web site. These details include the identity of the golfers expected to play in the tournament. These details update the software already available at the sponsor's web site so players visiting the sponsor's web site can make their predictions for the coming weekend tournament.

On the final day of the tournament as the players who have shot par become identified, the control computer matches the par shooters and the names of the participants who have correctly predicted the names of the par shooters so that when the last group of golfers completes their putting on the 18^{th} green, the control computer may be able to identify the winner or winners of the par golf Internet game. During the tournament, as each player finishes his round, the Operator may determine the name or each golfer who has a shot par and each golfer who has not shot par and in addition the names of all of the participants who have received a positive or negative score as a result. The Operator may preferably keep a running total of the points accumulated by each participant and may make available the names of the participants who have accumulated the best and maybe also the worst scores (such as the 100 best scores and the 100 worse scores. This should increase interest during the tournament for the participants. Preferably, determinations of the winners can be made within a few seconds or minutes after the tournament is over and as suggested above, the winners could probably be notified while the last group of golfers is walking off the 18th green.

Preferably, the game will be played on a national and maybe international scale with millions of players and huge prizes. However, this invention can just as well be practiced on a very small scale. For example, a single local sponsor might want to sponsor the game for his local customers numbering in the hundreds or thousands. In this case the prizes would typically be much smaller, but the game can be structured to give the participants a correspondingly better chance of winning.

### Other Methods of Determining Par Golf Internet Winners

There are many ways to determine the winners of the par golf Internet game in addition to the one described above. The game could obviously be changed to require the prediction of six, ten or any other reasonable number of final day par shooters. Prizes could be awarded on many different criteria. For example, in addition to the contest prize, a lessor prize could be awarded to everyone who predicts at least two par shooters.

If the game becomes very large, players could be required to make more precise predictions to reduce the probability of ties. For example, additional points could be awarded for predicting the golfers who finish first, second, third, fourth and fifth, with 8 points for second place, 6 points for third place, 4 points for fourth place and 2 points for fifth place. Correct predictions of ties for third place, for example would receive 10 points. In case of a tie the prize could be divided among the players who tied. Players could be asked to predict the score of the tournament winner and 5 points could be given for a correct prediction. Also, additional points, such as 4, 3, 2 and 1, could be given for correct predictions of the second, third, fourth and fifth finishers. The same point system could be used consistently for all tournaments or the number of points given and subtracted could be changed for every tournament or from time to time.

### Advantages

Applicant believes this invention will provide huge benefits to every aspect of the golf industry, including: Sponsors, the PGA, tour golf courses, golf equipment manufacturers, the PGA golfers and the players of the Par Golf Internet Game.

The game of golf is still growing in popularity and new golf tours have been announced with very large cash prizes for the players. The US PGA Tour has also announced a major increase in prize money to stay competitive. However, these monetary increases only benefit the respective tours and their players; there is no benefit to the fans. Par Golf will correct that. Par Golf is unique in corruptible and will only benefit participants and sponsors.

### The Sponsors

The Operator may seek Sponsors to help defray the cost of providing the par golf Internet game. In such case, the sponsors could include golf equipment makers and apparel manufacturers. Also golf courses and driving ranges could be sponsors. Other potential sponsors include automobile manufacturers, insurance companies and other corporations that typically sponsor the golf tournaments. Each participant who visits a sponsor's web site to make a predication can be provided with information from the sponsor about the sponsor and its products or services. The cost to the sponsor will only be a fee paid to the Operator. To give the Par Golf players an incentive to utilize the web site of a particular sponsor, the sponsor may choose to offer additional prizes to players who utilize the sponsor's web site.

### The PGA Tour

This par golf Internet game will make the weekly PGA tournament much more popular. It should greatly increase the number of television or web site viewers and exposure for their advertisers.

### The PGA Golfers

The PGA golfers will become much more popular. The average tournament golfers will become better known, because it will be the average players who are much more likely to shoot par than the golfers who are most likely to win the tournaments. Players of the PGIG will begin to focus as much attention on who is going to shoot par as who is going to win the tournament.

### Par Golf Participants

The Par Golf players who have made predictions will find the weekly tournaments much more interesting in that they will have a chance of winning valuable prizes. Participants will become much more familiar with the names of the professional golfers and the Participants will watch carefully the scores of the golfers on which the players have made predictions

### Average Golfers

Typical average golfers will benefit by watching a wide variety of golfers in a wide variety of situations. These golfers can choose to watch a particular golfer that has a style like one that the average golfer would like to develop. The monitors who are following each twosome will be expected to provide commentary during the tournament in between golf shots regarding features of the professional golfer's game

It is to be understood that while certain forms of the present invention have been illustrated and described herein, it is not to be limited to the specific forms or arrangement of parts described and shown. So, the scope of the present invention shall be determined by the appended claims and their equivalents.

1. A game for recording and transmitting the activity of each group of golfers playing in a golf tournament at a tournament site and permitting participants in the game to win points in the game by accurately predicting the golfers who will shoot par during the last round of the golf tournament, said game comprising:
A) a plurality of video cameras operated by monitors assigned to each group of golfers competing in the tournament, wherein the monitors utilize the video cameras to record and transmit in real time the activity, including images and sound, of the golfers in each group of golfers,
B) a communication network programmed to:
1) to communicate with potential and actual contest players to permit the contest players to easily make their predictions of par shooters from a list of golfers provided by the operator utilizing a fill-in-the-blanks form,
2) to transmit tournament activity of each group of golfers competing in the tournament to a national or international audience,
C) a tournament computer server programmed to receive communications from each of the monitors and further transmitted through the Internet to make all or almost all the golf shots of each tournament golfer available substantially real time and live to any person with access to the communication network,
D) a player board in communication with the tournament computer server comprising a plurality of monitors provided at the tournament site of on which monitors provide substantially real time, live images of all the tournament golfers;
wherein the participants utilize the communication network to:
1) predict the golfers who will shoot par on the last day of the tournament,
2) comply with the operator's requirements to participate in the game.

2. The game as in claim 1 wherein the contest players are also asked to predict the number of shots under PAR of the winner of the tournament during the last day of the tournament and will contest players will receive additional points for correct predictions.

3. The game as in claim 1 wherein the communication network is the Internet.

4. The game as in claim 1 wherein sponsors purchase a number of the special codes from the contest operator and make them available to their customers, clients and/or web site visitors permitting their customers, clients, or web site visitors to play the contest game for free.

5. The game as in claim 1 wherein contests players choose whether they pay a fee to play the contest but the prize for the winner or winners is greater if they choose to pay the fee.

6. The game as in claim 1 wherein the contest winner is determined based on a point system.

7. The game as in claim 7 wherein contest players are given one point for each correct pick of par shooters minus one point for each incorrect pick of par shooters.

8. The game as in claim 1 wherein the operator's requirements includes the participant utilizing the communication network and one or more credit card systems to pay a fee to play the game.
